(19) United States
(12) Patent Application Publication
(10) Pub. No.: US 2025/0299501 A1
(43) Pub. Date: Sep. 25, 2025

(54) LANE DIVISION LINE DETECTION DEVICE

(71) Applicant: TOYOTA JIDOSHA KABUSHIKI KAISHA, Toyota-shi (JP)

(72) Inventor: Tomoki IRI, Tsukuba-shi (JP)

(73) Assignee: TOYOTA JIDOSHA KABUSHIKI KAISHA, Toyota-shi (JP)

(21) Appl. No.: 19/008,103

(22) Filed: Jan. 2, 2025

(30) Foreign Application Priority Data
Mar. 19, 2024 (JP) 2024-043057

(51) Int. Cl. G06V 20/56; B60W 40/06

(52) U.S. Cl. CPC G06V 20/588; B60W 40/06; B60W 2555/20

(57) ABSTRACT

The lane division line detection device includes a processor configured to: determine which to use for detecting a lane division line out of a camera for capturing surroundings of a vehicle and a temperature sensor for detecting a temperature distribution around the vehicle, the camera and the temperature sensor being mounted on the vehicle, based on a visibility index indicating how the road surface is viewed by the camera, detect the lane division line based on an image representing the surroundings of the vehicle generated by the camera when the camera is used, and detect the lane division line based on a temperature distribution signal representing the temperature distribution around the vehicle generated by the temperature sensor when the temperature sensor is used.

### FIELD

The present invention relates to a lane division line detection device that detects a lane division line.

### BACKGROUND

In order to control autonomous driving of a vehicle or to support the driving of a driver of the vehicle, it is required to accurately detect a lane division line that separates a lane in which the vehicle is traveling from another lane. Therefore, an output from a line sensor, which is an infrared detection sensor, is analyzed, and a point at which the output becomes low is recognized as a white line (see Japanese Unexamined Patent Publication No. 2006-298006).

### SUMMARY

The temperature distribution of a road surface can be obtained by an infrared detection sensor, and a white line is detected based on the temperature distribution. However, depending on the situation of the road surface, the temperature difference between the white line and the other portions on the road surface may not be clear. In such a case, it may be difficult to detect the white line based on the temperature distribution.

An object of the present invention is to provide a lane division line detection device capable of detecting a lane division line regardless of the situation of a road surface.

According to one embodiment, a lane division line detection device is provided. The lane division line detection device includes a processor configured to: determine which to use for detecting a lane division line out of a camera for capturing surroundings of a vehicle and a temperature sensor for detecting a temperature distribution around the vehicle, the camera and the temperature sensor being mounted on the vehicle, based on a visibility index indicating how a road surface is viewed by the camera, detect the lane division line based on an image representing the surroundings of the vehicle generated by the camera when the camera is used, and detect the lane division line based on a temperature distribution signal representing the temperature distribution around the vehicle generated by the temperature sensor when the temperature sensor is used.

In one embodiment, the processor determines that the temperature sensor is used for detecting the lane division line when the visibility index indicates a state in which the lane division line cannot be visually recognized in the image, and determines that the camera is used for detecting the lane division line when the visibility index indicates a state in which the lane division line can be visually recognized in the image.

In one embodiment, the processor refers to an index indicating whether or not the road surface is wet as the visibility index, and when the visibility index indicates that the road surface is wet, the processor determines that the temperature sensor is used for detecting the lane division line.

In this case, the processor calculates the visibility index by inputting the image to a classifier learned in advance so as to determine whether or not the road surface is wet.

In one embodiment, the processor calculates a ratio of the number of images in which the detection of the lane division line fails to the number of the plurality of images generated by the camera within a latest predetermined period as the visibility index, and determines that the temperature sensor is used for detecting the lane division line when the ratio is equal to or larger than a predetermined ratio.

The lane division line detection device according to the present disclosure has an advantageous effect of being able to detect a lane division line regardless of the situation of a road surface.

### BRIEF DESCRIPTION OF DRAWINGS

FIG. 1 schematically illustrates the configuration of a vehicle control system on which a lane division line detection device is mounted.

FIG. 2 illustrates the hardware configuration of an electronic control unit, which is an embodiment of the lane division line detection device.

FIG. 3 is a functional block diagram of a processor of the electronic control unit relating to a vehicle control process including a lane division line detection process.

FIG. 4A is a diagram for explaining an outline of a lane division line detection process.

FIG. 4B is a diagram for explaining an outline of a lane division line detection process.

FIG. 5 is an operation flowchart of the vehicle control process including the lane division line detection process.

### DESCRIPTION OF EMBODIMENTS

Hereinafter, a lane division line detection device, a lane division line detection method and a lane division line detection computer program executed by the lane division line detection device will be described with reference to the attached drawings. The lane division line detection device detects a lane division line of a road on which a vehicle is traveling by using a camera that captures an image of the surroundings of the vehicle or a temperature sensor that detects a temperature distribution around the vehicle. In particular, the lane division line detection device determines which of the camera and the temperature sensor is to be used for detecting the lane division line, based on a visibility index indicating how the road surface is viewed by the camera.

Hereinafter, an example in which the lane division line detection device is applied to the vehicle control system will be described. In this example, the lane division line detection device detects a lane division line that divides a lane in which the vehicle is traveling (hereinafter, sometimes referred to as a host lane) by executing the lane division line detection process, and uses the detection result for autonomous driving control of the vehicle.

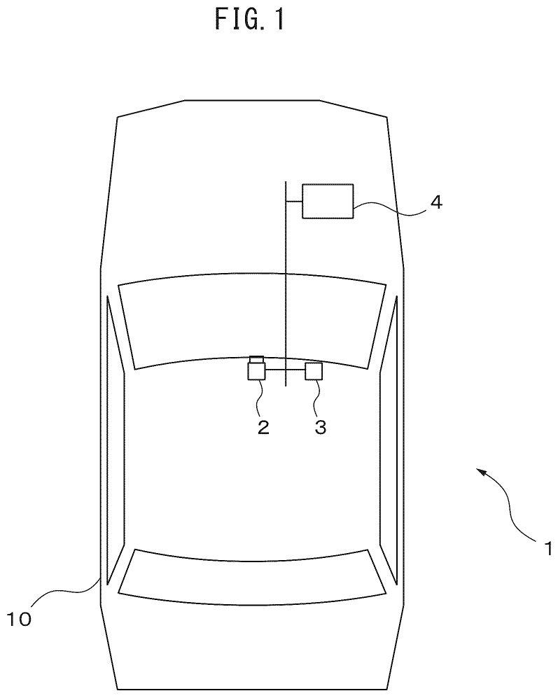

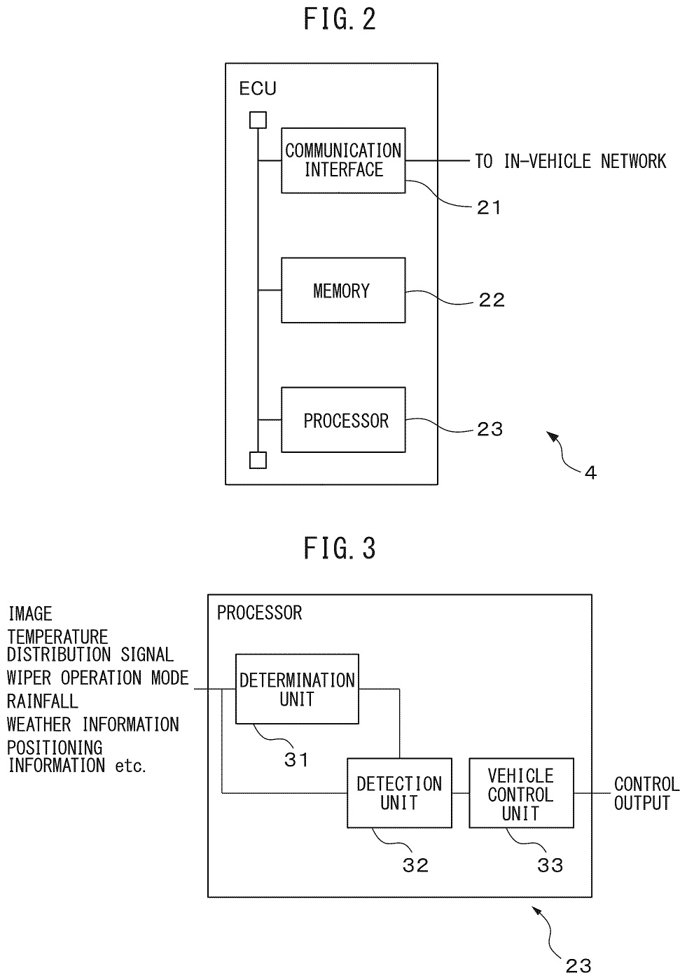

FIG. 1 schematically illustrates the configuration of a vehicle control system on which the lane division line detection device is mounted. FIG. 2 illustrates the hardware configuration of an electronic control unit, which is an embodiment of the lane division line detection device. In the present embodiment, the vehicle control system 1 mounted on the vehicle 10 and controlling the vehicle 10 includes a camera 2, a temperature sensor 3, and an electronic control unit (ECU) 4 that is an example of the lane division line detecting device. The camera 2, the temperature sensor 3, and the ECU 4 are communicably connected via an in-vehicle network. The vehicle control system 1 may further include a storage device (not shown) that stores a map used for autonomous driving control of the vehicle 10. Further, the vehicle-control system 1 may include a range sensor (not shown) such as a LiDAR sensor or a radar. Furthermore, the vehicle control system 1 may include a receiver (not shown) for determining the position of the vehicle 10 in accordance with a satellite-positioning system, such as a GPS receiver. Furthermore, the vehicle control system 1 may include a wireless communication terminal (not shown) for wirelessly communicating with other devices.

The camera 2 is mounted on the vehicle 10 toward a predetermined region including a road surface around the vehicle 10 (for example, a front region of the vehicle 10) such that the predetermined region is included in an imaging range of the camera 2. Then, the camera 2 captures the predetermined region every predetermined capturing cycle (for example, 1/30 second to 1/10 second) and generates an image in which the predetermined region is represented. The vehicle 10 may be provided with a plurality of cameras having different shooting directions or different focal lengths.

Each time an image is generated, the camera 2 outputs the generated image to the ECU 4 via the in-vehicle network.

The temperature sensor 3 is a sensor that measures a temperature distribution in a predetermined region including a road surface around the vehicle 10, and is, for example, thermography. The temperature sensor 3 is attached to the vehicle 10 so as to face the predetermined region to be measured, and generates a temperature distribution signal representing a temperature distribution in the predetermined region at predetermined intervals. Each time the temperature distribution signal is generated, the temperature sensor 3 outputs the generated temperature distribution signal to the ECU 4 via the in-vehicle network.

The ECU 4 controls the vehicles 10. To this end, the ECU 4 includes a communication interface 21, a memory 22 and a processor 23.

The communication interface 21 is an example of a communication unit and includes interface circuitry for connecting the ECU 4 to the in-vehicle network. That is, the communication interface 21 is connected to the camera 2 and the temperature sensor 3 via the in-vehicle network. The communication interface 21 then passes the image received from the camera 2 and the temperature distribution signal received from the temperature sensor 3 to the processor 23. In addition, the communication interface 21 transmits, to the processor 23, a map read from the storage device, positioning information from the GPS receiver, and the like received via the in-vehicle network.

The memory 22 is an example of a storage unit, and includes, for example, a volatile semiconductor memory and a non-volatile semiconductor memory. The memory 22 stores a computer program for realizing various processes executed by the processor 23 of the ECU 4. Further, the memory 22 stores various kinds of data used in the lane division line detection process, for example, an image received from the camera 2, a temperature distribution signal received from the temperature sensor 3, various kinds of parameters for specifying a classifier used in the lane division line detection process, and the like. Furthermore, the memory 22 stores various types of data generated during the lane division line detection process.

The processor 23 is an example of a controller and includes one or more central processing units (CPUs) and a peripheral circuit thereof. The processor 23 may further include another operating circuit, such as a logic-arithmetic unit, an arithmetic unit, or a graphics processing unit. The processor 23 executes vehicle control processing including lane division line detection processing while the vehicle 10 is traveling. Then, the processor 23 detects a lane division line of the host lane from the image obtained by the camera 2 or the temperature distribution signal obtained by the temperature sensor 3 and controls the vehicle 10 for autonomous driving of the vehicle 10 or for supporting driving of the driver of the vehicle 10 based on the detected lane division line.

FIG. 3 is a functional diagram of the processor 23 of the ECU 4 relating to the vehicle control process including the lane division line detecting process. The processor 23 includes a determination unit 31, a detection unit 32, and a vehicle control unit 33. Each of these units included in the processor 23 is a functional module, for example, implemented by a computer program running on the processor 23. Alternatively, each of these units included in the processor 23 may be a dedicated operating circuit provided in the processor 23. Among these units included in the processor 23, the determination unit 31 and the detection unit 32 execute the lane division line detection process.

The determination unit 31 determines which of the camera 2 and the temperature sensor 3 is to be used for detecting a lane division line, based on a visibility index indicating how a road surface is viewed by the camera 2. Specifically, when the visibility index indicates that the lane division line cannot be visually recognized in the image generated by the camera 2, the determination unit 31 determines that the temperature sensor 3 is used for detecting the lane division line. On the other hand, when the visibility index indicates that the lane division line can be visually recognized in the image, the determination unit 31 determines that the camera 2 is used for detecting the lane division line. As described above, the determination unit 31 determines a sensor to be used for detecting the lane division line from the camera 2 and the temperature sensor 3 in accordance with the visual recognition state of the road surface. As a result, it is possible to detect the lane division line regardless of the situation of the road surface, in particular the situation regarding the visibility of the road surface from the camera 2.

In one embodiment, the determination unit 31 refers to an index indicating whether or not the road surface is wet as a visibility index. When the road surface is wet, it may be difficult to identify the lane division line on the image generated by the camera 2 because the amount of light reflected by the layer of water on the road surface increases. On the other hand, in a situation where the road surface is dry, the identification of the lane division line on the image is relatively easy. Therefore, when the visibility index indicates that the road surface is wet, the determination unit 31 determines that the temperature sensor 3 is used for detecting the lane division line. On the other hand, when the visibility index indicates that the road surface is not wet, the determination unit 31 determines that the camera 2 is used for detecting the lane division line.

As an index indicating whether or not the road surface is wet, the determination unit 31 refers to a signal that is received from a body ECU (not shown) that controls the wiper and indicates an operation mode of the wiper that is currently applied. For example, when the currently applied operation mode of the wiper is a mode in which the wiper continuously operates, the determination unit 31 determines that the road surface is wet, and as a result, determines that the temperature sensor 3 is used for detecting the lane division line. On the other hand, when the operation mode of the wiper is a mode other than the above, the determination unit 31 determines that the road surface is not wet, and as a result, determines that the camera 2 is used for detecting the lane division line.

Alternatively, as an index indicating whether or not the road surface is wet, the determination unit 31 may refer to a measurement value of a rainfall sensor (not shown) provided in the vehicle 10. In this case, when the measured value of the rainfall sensor is equal to or larger than the predetermined threshold value, the determination unit 31 determines that the road surface is wet, and as a result, determines that the temperature sensor 3 is used for detecting the lane division line. On the other hand, when the measured value of the rainfall sensor is less than the predetermined threshold value, the determination unit 31 determines that the road surface is not wet, and as a result, determines that the camera 2 is used for detecting the lane division line.

Alternatively, as an index indicating whether or not the road surface is wet, the determination unit 31 may refer to weather information received via a wireless communication terminal (not shown) provided in the vehicle 10. In this case, when the current position of the vehicle 10 is included in an area in which the weather information indicates that there is rainfall or snowfall (hereinafter referred to as a rainfall area), the determination unit 31 determines that the road surface is wet, and as a result, determines that the temperature sensor 3 is used for detecting the lane division line. On the other hand, when the current position of the vehicle 10 is outside the rainfall area, the determination unit 31 determines that the road surface is not wet, and as a result, determines that the camera 2 is used for detecting the lane division line. The determination unit 31 may set the latest position of the vehicle 10 positioned by a GPS receiver (not shown) mounted on the vehicle 10 as the present position of the vehicle 10.

Alternatively, the determination unit 31 may calculate an index value indicating whether or not the road surface is wet by inputting an image generated by the camera 2 to a classifier learned in advance so as to determine whether or not the road surface is wet. The classifier may be, for example, a so-called deep neural network (DNN) based classifier, in particular a convolutional neural network (CNN). The classifier includes one or more convolutional layers, one or more fully connected layers, and an output layer in order from the input side, and the output layer calculates, by softmax calculation or sigmoid calculation, a reliability indicating that the road surface is wet. When the calculated index value is equal to or larger than the predetermined threshold value, the determination unit 31 determines that the road surface is wet, and as a result, determines that the temperature sensor 3 is used for detecting the lane division line. On the other hand, when the calculated index value is less than the predetermined threshold value, the determination unit 31 determines that the road surface is not wet, and as a result, determines that the camera 2 is used for detecting the lane division line.

Such a classifier is learned in advance according to a predetermined learning method such as a back propagation method using a large number of teacher images including an image representing a situation in which the road surface is wet and an image representing a situation in which the road surface is not wet. The classifier is not limited to the above-described example, and may be a classifier learned based on a machine learning technique other than DNN such as a support vector machine.

The determination unit 31 may determine whether or not the road surface is wet by referring to a plurality of indices indicating whether or not the road surface is wet, as described above. In this case, when any of the indices indicates that the road surface is wet, the determination unit 31 may determine that the road surface is wet, and as a result, may determine that the temperature sensor 3 is used for detecting the lane division line. On the other hand, when none of the indices indicates that the road surface is wet, the determination unit 31 may determine that the road surface is not wet, and as a result, may determine that the camera 2 is used for detecting the lane division line.

Further, the determination unit 31 may use an index other than the index indicating whether or not the road surface is wet as the visibility index. For example, the determination unit 31 may calculate a ratio of the number of images in which the detection of the lane division line by the detection unit 32 fails to the number of the plurality of images generated by the camera 2 within the latest predetermined period as the visibility index. In this case, when the ratio is equal to or greater than the predetermined ratio, the determination unit 31 determines that the temperature sensor 3 is used for detecting the lane division line. On the other hand, if the ratio is less than the predetermined ratio, the determination unit 31 determines that the camera 2 is used for detecting the lane division line.

Note that, depending on the road section in which the vehicle 10 is traveling, a lane division line may not be provided in the first place. Therefore, the determination unit 31 refers to a map and the position of the vehicle 10 at the time of generating the image when the lane division line is not detected by the detection unit 32, and specifies the road section in which the vehicle 10 was traveling at the time of generating the image. Then, the determination unit 31 may determine that the detection of the lane division line by the detection unit 32 has failed when the lane division line is not detected from the image even though the lane division line is represented in the map for the identified road section. On the other hand, when the lane division line is not represented in the map for the identified road section, even if the lane division line is not detected from the image, the determination unit 31 does not determine that the detection of the lane division line by the detection unit 32 has failed.

In addition, in a case where the temperature sensor 3 is used for detecting the lane division line in the latest predetermined period, the determination unit 31 may calculate a ratio of the number of the temperature distribution signals in which the detection of the lane division line by the detection unit 32 fails to the number of the plurality of temperature distribution signals generated by the temperature sensor 3 within the latest predetermined period as the visibility index. In this case, when the ratio is equal to or greater than the predetermined ratio, the determination unit 31 determines that the camera 2 is used for detecting the lane division line. On the other hand, if the ratio is less than the predetermined ratio, the determination unit 31 determines that the temperature sensor 3 is used for detecting the lane division line.

The determination unit 31 notifies the detection unit 32 of the determination result of the sensor used for detecting the lane division line.

The detection unit 32 detects a lane division line provided in a road section in which the vehicle 10 is traveling by using a sensor that is determined by the determination unit 31 to be used for detecting the lane division line out of the camera 2 and the temperature sensor 3.

When the camera 2 is used for detecting a lane division line, the detection unit 32 inputs the image generated by the camera 2 to a classifier learned in advance so as to detect the lane division line, thereby detecting the lane division line represented in the image. As the classifier for detecting a lane division line, a DNN having a CNN type architecture for semantic segmentation such as fully convolution network (FCN) or U-Net is used. As the classifier for detecting a lane dividing line, a classifier based on a machine learning system other than DNN, such as a classifier for semantic segmentation based on random forest, may be used. Alternatively, the detection unit 32 may detect a lane division line based on the edge intensity on the image. In this case, the detection unit 32 calculates, for each of scanning lines in the horizontal direction in which the vertical positions on the image are different from each other, the edge intensity in the horizontal direction for each pixel along the scanning line, and sets a pixel whose edge intensity is equal to or greater than a predetermined detection threshold value as a candidate pixel representing a candidate of a boundary between the lane division line and the periphery thereof. Then, the detection unit 32 detects the lane division line by determining, for each scanning line, a combination of candidate pixels separated by a distance on an image corresponding to the width of the lane division line and the lane width as a combination of boundary pixels representing the boundary between the lane division line and the periphery thereof.

The detection unit 32 sets two lane dividing lines closest to the position of the vehicle 10 on the image among the individual lane division lines detected from the image as lane division lines that divide the host lane.

Similarly, in the case where the temperature sensor 3 is used for detecting a lane division line, the detection unit 32 inputs the temperature distribution signal generated by the temperature sensor 3 to a classifier learned in advance so as to detect the lane division line, thereby detecting the lane division line represented in the temperature distribution signal. As a classifier for detecting a lane division line, for example, a DNN having a CNN architecture for semantic segmentation or a classifier based on a machine learning system other than DNN is used. Alternatively, the detection unit 32 may detect the lane division line by calculating the edge intensity of each pixel in the temperature distribution signal. Then, the detection unit 32 sets the two lane division lines closest to the position of the vehicle 10 on the temperature distribution signal among the individual lane division lines detected from the temperature distribution signal as lane division lines that divide the host lane.

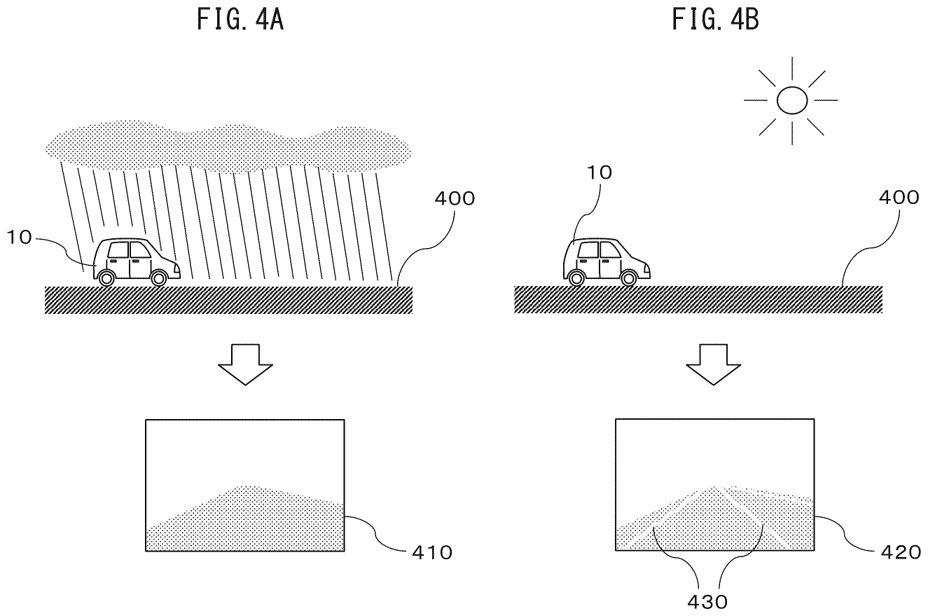

FIGS. 4A and 4B are diagrams for explaining the outline of the lane division line detecting process, respectively. In the embodiment shown in FIG. 4A, it is raining around the vehicle 10 and the road surface 400 around the vehicle 10 is wet. Therefore, in the image 410 obtained by the camera 2, the lane division line is indistinguishably obscured. Therefore, the temperature sensor 3 is used for detecting the lane dividing line.

On the other hand, in the embodiment shown in FIG. 4B, the weather around the vehicle 10 is sunny, and the road surface 400 around the vehicle 10 is not wet. Therefore, the lane division line 430 is clearly represented in the image 420 obtained by the camera 2. Therefore, the camera 2 is used for detecting the lane division line.

Furthermore, the detection unit 32 may detect an object that can affect the traveling of the vehicle 10, such as another vehicle traveling around the vehicle 10, a road sign, and a curb, from an image by the camera 2. In this case, the detection unit 32 may detect such an object by inputting the image to a classifier learned in advance so as to detect the object from the image. Such a classifier may be a CNN for detecting an object, such as Faster R-CNN or Single Shot MultiBox Detector.

The detection unit 32 notifies the vehicle control unit 33 of the detection result of the lane division line. Furthermore, when a predetermined object such as another vehicle is detected, a detection result of the object is also notified to the vehicle control unit 33.

The vehicle control unit 33 executes autonomous driving control so that the vehicle 10 continues traveling along the host lane while traveling on the basis of the detected lane division lines. At this time, the vehicle control unit 33 controls the steering of the vehicle 10 so that the vehicle 10 travels at the center of the two lane division lines that divide the host lane. Alternatively, in the case of assisting driving of the driver, when the distance between any lane division line and the vehicle 10 becomes equal to or less than a predetermined threshold value, the vehicle control unit 33 controls the steering of the vehicle 10 so as to be separated from the lane division line, or warns the driver of the deviation of the vehicle 10 from the host lane via a notification device (not shown). In a case where the lane division line is detected from the image, since the parameters of the camera 2 such as the attachment position of the camera 2, the imaging direction, and the angle of view are known, the vehicle control unit 33 can estimate the distance between the vehicle 10 and the lane division line on the basis of the position of the lane division line on the lowermost end side of the image. Similarly, even when the lane division line is detected from the temperature distribution signal, the vehicle control unit 33 can estimate the distance between the vehicle 10 and the lane division line on the basis of the parameter of the temperature sensor 3 and the position of the lane division line on the lowermost end side of the temperature distribution signal.

Further, the vehicle control unit 33 controls the accelerator or the brake so that the speed of the vehicle 10 approaches the target speed. Further, when another vehicle traveling in front of the vehicle 10 is detected and the distance between the other vehicle and the vehicle 10 is less than the predetermined distance threshold, the vehicle control unit 33 controls the accelerator or the brake to decelerate the vehicle 10 so that the distance becomes equal to or greater than the distance threshold. Since it is assumed that the position of the lower end of the region where the other vehicle is represented on the image represents the position where the other vehicle is in contact with the road surface, the vehicle control unit 33 can estimate the distance between the vehicle 10 and the other vehicle based on the position of the lower end of the region on the image and parameters such as the attachment position of the camera 2, the imaging direction, and the angle of view. In addition, when a range sensor such as a LiDAR or a radar is attached to the vehicle 10, the vehicle control unit 33 may estimate the distance measured by the range sensor for the azimuth corresponding to the region where the other vehicle is represented on the image as the distance between the vehicle 10 and the other vehicle.

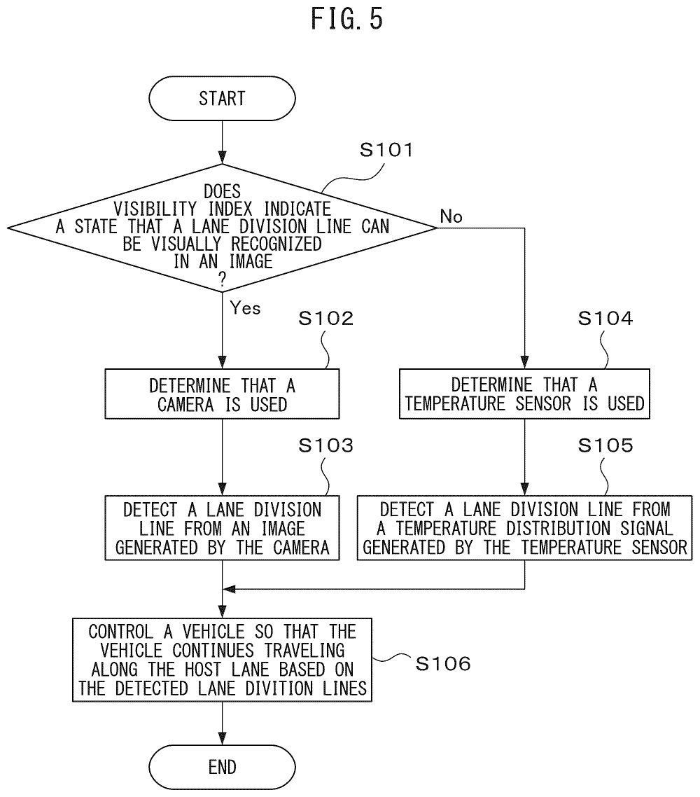

FIG. 5 is an operation flowchart of the vehicle control process including the lane division line detection process. The processor 23 executes the vehicle control process according to the operation flowchart shown below. In the operation flow chart shown below, the process of the steps S101 to S105 corresponds to the lane division line detecting process.

The determination unit 31 determines whether or not the visibility index indicates that the lane division line can be visually recognized in the image by the cameras 2 (step S101). When the visibility index indicates that the lane division line can be visually recognized in the image by the camera 2 (step S101—Yes), the determination unit 31 determines that the camera 2 is used to detect the lane division line (step S102). Then, the detecting unit 32 detects the lane division line based on the image generated by the cameras 2 (step S103).

On the other hand, when the visibility index indicates that the lane division line cannot be visually recognized in the image by the cameras 2 (step S101—No), the determination unit 31 determines that the temperature sensor 3 is used to detect the lane division line (step S104). Then, the detecting unit 32 detects the lane division line based on the temperature distribution signal generated by the temperature sensor 3 (step S105).

After the step S103 or S105, the vehicle control unit 33 controls the vehicle 10 so that the vehicle 10 continues traveling along the host lane on the basis of the detected left and right lane division lines of the host lane (step S106). Then, the processor 23 ends the vehicle control process.

As described above, the lane division line detection device determines which of the camera and the temperature sensor is to be used for detecting the lane division line based on the visibility index indicating how a road surface is viewed by the camera. Therefore, the lane division line detection device can detect the lane division line regardless of the situation of the road surface.

The computer program for realizing the functions of the respective units of the processor 23 of the lane division line detection device according to the above-described embodiment may be provided in a form recorded in a computer-readable portable recording medium such as a semiconductor memory, a magnetic recording medium, or an optical recording medium.

As described above, a skilled person can make various modifications according to the embodiment within the scope of the present invention.

What is claimed is:

1. A lane division line detection device comprising:
a processor configured to:
determine which to use for detecting a lane division line out of a camera for capturing surroundings of a vehicle and a temperature sensor for detecting a temperature distribution around the vehicle, the camera and the temperature sensor being mounted on the vehicle, based on a visibility index indicating how a road surface is viewed by the camera,
detect the lane division line based on an image representing the surroundings of the vehicle generated by the camera when the camera is used, and
detect the lane division line based on a temperature distribution signal representing the temperature distribution around the vehicle generated by the temperature sensor when the temperature sensor is used.

2. The lane division line detection device according to claim 1, wherein the processor determines that the temperature sensor is used for detecting the lane division line when the visibility index indicates a state in which the lane division line cannot be visually recognized in the image, and determines that the camera is used for detecting the lane division line when the visibility index indicates a state in which the lane division line can be visually recognized in the image.

3. The lane division line detection device according to claim 1, wherein the processor refers to an index indicating whether or not the road surface is wet as the visibility index, and when the visibility index indicates that the road surface is wet, the processor determines that the temperature sensor is used for detecting the lane division line.

4. The lane division line detection device according to claim 3, wherein the processor calculates the visibility index by inputting the image to a classifier learned in advance so as to determine whether or not the road surface is wet.

5. The lane division line detection device according to claim 1, wherein the processor calculates a ratio of the number of images in which the detection of the lane division line fails to the number of the plurality of images generated by the camera within a latest predetermined period as the visibility index, and determines that the temperature sensor is used for detecting the lane division line when the ratio is equal to or larger than a predetermined ratio.
